(19) United States
(12) Patent Application Publication
(10) Pub. No.: US 2019/0023235 A1
(43) Pub. Date: Jan. 24, 2019

(54) Spraying Device

(71) Applicant: Branko Vidovic, Toronto (CA)

(72) Inventor: Branko Vidovic, Toronto (CA)

(21) Appl. No.: 15/653,012

(22) Filed: Jul. 18, 2017

(51) Int. Cl. B60S 3/04; B05B 9/04; B05B 12/00

(52) U.S. Cl. CPC B60S 3/047; B60S 3/044; B05B 12/002; B05B 9/0426

(57) ABSTRACT

A spraying device for deicing vehicle windows includes a shell that defines an interior space. The shell is configured to position a deicing solution, such as windshield washing fluid. A housing that defines an internal space is coupled to the shell. A power module and a pump are coupled to the housing and are positioned in the internal space. The pump is fluidically coupled to the interior space and is operationally coupled to the power module. A tube is fluidically coupled to the pump and extends from the shell. The tube is flexible. A nozzle is coupled to the tube distal from the shell. The pump is configured to motivate the deicing solution from the interior space through the tube. The nozzle is configured to spray the deicing solution on a target, such as a window of a vehicle, such that ice on the target is melted.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to spraying devices and more particularly pertains to a new spraying device for deicing vehicle windows.

### BRIEF SUMMARY OF THE INVENTION

An embodiment of the disclosure meets the needs presented above by generally comprising a shell that defines an interior space. The shell is configured to position a deicing solution, such as windshield washing fluid. A housing that defines an internal space is coupled to the shell. A power module and a pump are coupled to the housing and are positioned in the internal space. The pump is fluidically coupled to the interior space and is operationally coupled to the power module. A tube is fluidically coupled to the pump and extends from the shell. The tube is flexible. A nozzle is coupled to the tube distal from the shell. The pump is configured to motivate the deicing solution from the interior space through the tube. The nozzle is configured to spray the deicing solution on a target, such as a window of a vehicle, such that ice on the target is melted.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a spraying device according to an embodiment of the disclosure.

FIG. 2 is a bottom view of an embodiment of the disclosure.

FIG. 3 is a front view of an embodiment of the disclosure.

FIG. 4 is cross-sectional view of an embodiment of the disclosure.

FIG. 5 is an in-use view of an embodiment of the disclosure.

### DETAILED DESCRIPTION OF THE INVENTION

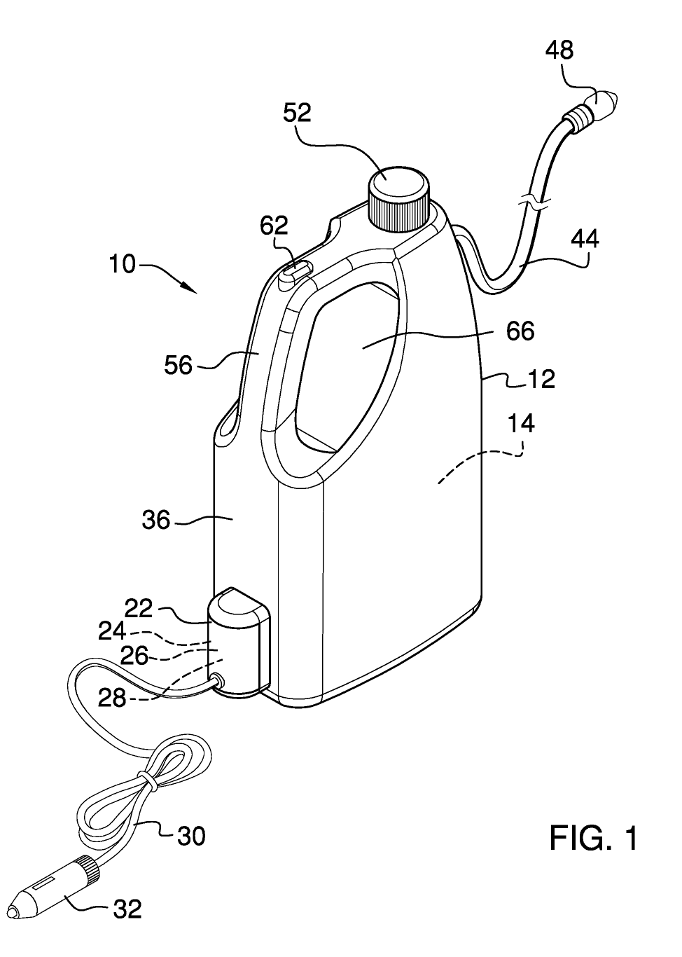

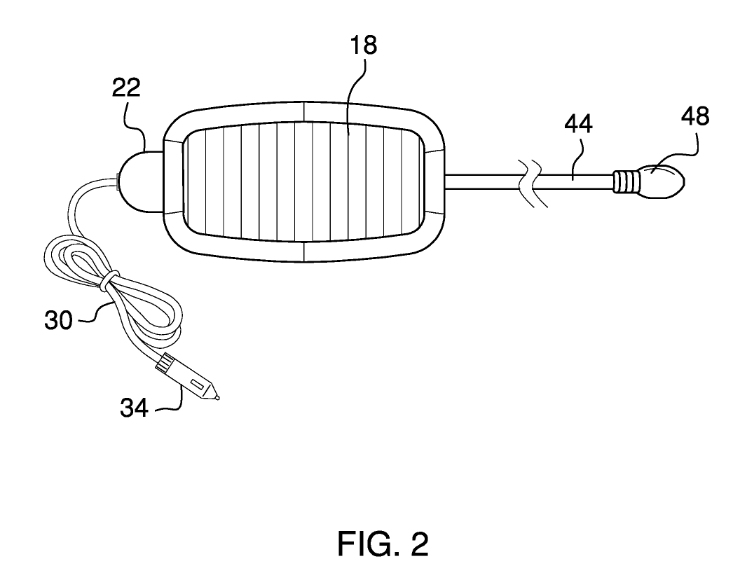

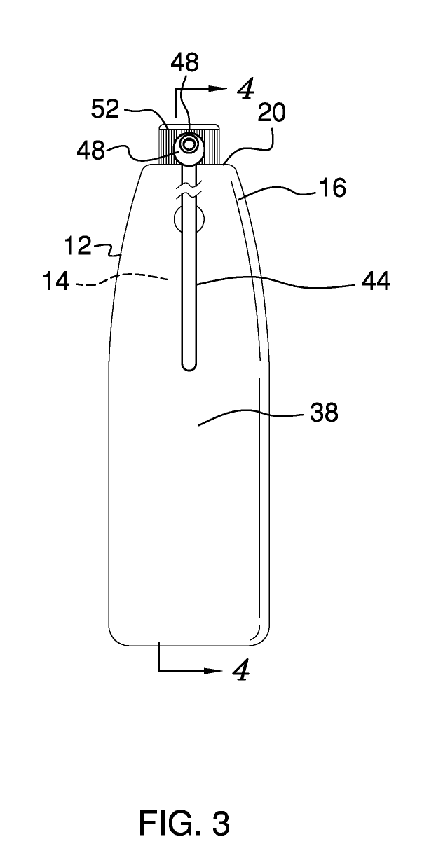

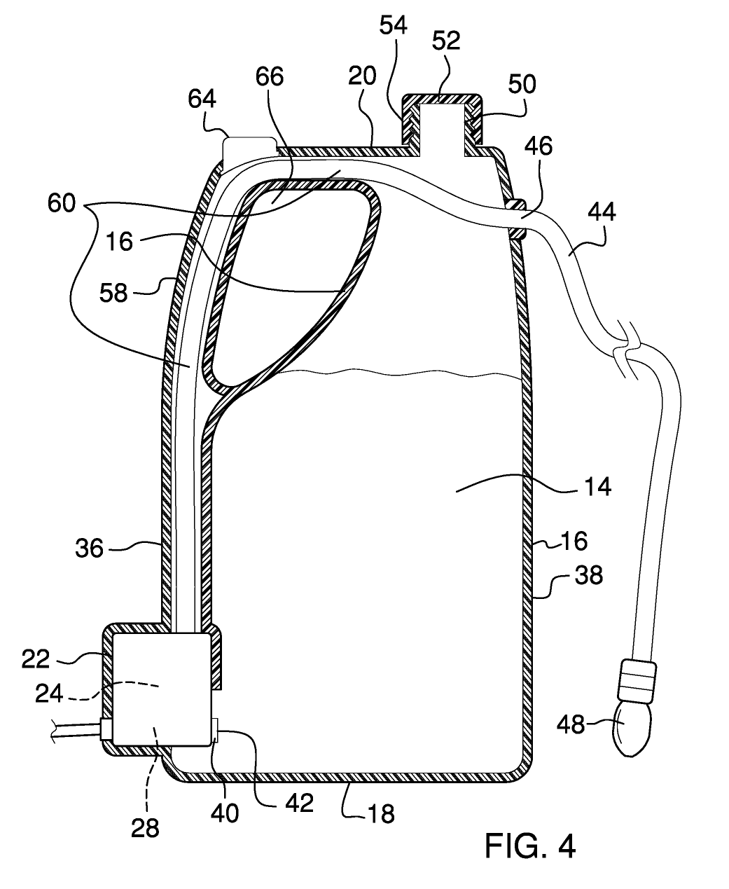

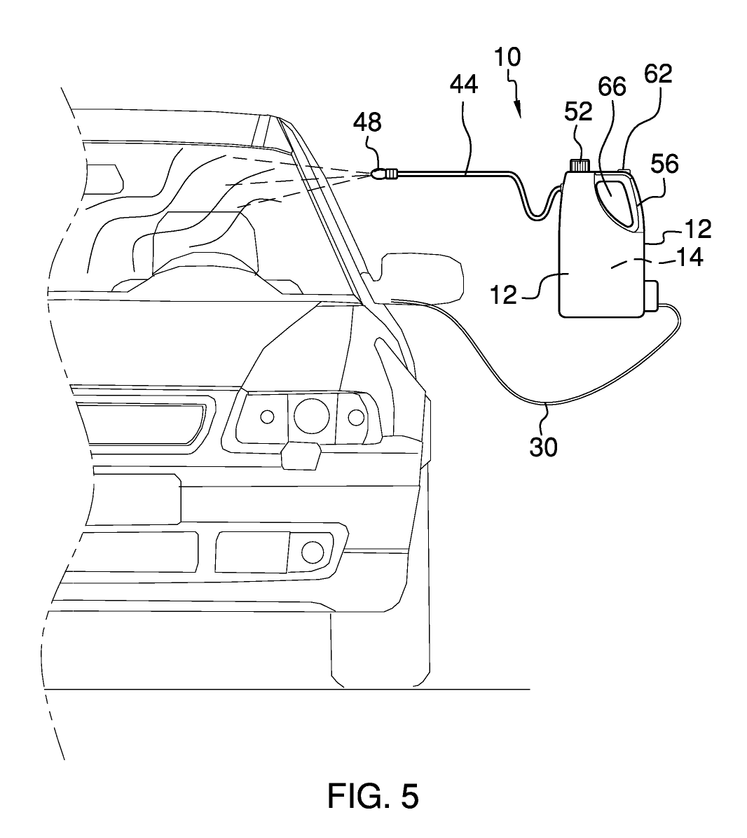

With reference now to the drawings, and in particular to FIGS. 1 through 5 thereof, a new spraying device embodying the principles and concepts of an embodiment of the disclosure and generally designated by the reference numeral 10 will be described.

As best illustrated in FIGS. 1 through 5, the spraying device 10 generally comprises a shell 12 that defines an interior space 14. The shell 12 is configured to position a deicing solution, such as windshield washing fluid. The shell 12 comprises an annular wall 16 extends from a bottom 18 to a top 20. In one embodiment, the bottom 18 is substantially rectangularly shaped and the shell 12 is substantially rectangularly box shaped. In another embodiment, the top 20 is dimensionally smaller than the bottom 18 and the shell 12 is tapered.

A housing 22 is coupled to the shell 12. The housing 22 defines an internal space 24. The housing 22 is positioned proximate to the bottom 18 on a back 36 of the shell 12.

A power module 26 and a pump 28 are coupled to the housing 22 and are positioned in the internal space 24. The pump 28 is fluidically coupled to the interior space 14. The pump 28 is operationally coupled to the power module 26.

In one embodiment, the power module 26 comprises a cable 30 and a connector 32. The cable 30 extends from the housing 22. The connector 32 is coupled to the cable 30 distal from the housing 22. In another embodiment, the connector 32 comprises a cigarette lighter plug 34.

A first pipe 40 is fluidically coupled to and extends from the pump 28. The first pipe 40 is positioned through the housing 22 such that an open end 42 of the first pipe 40 is positioned in the interior space 14 adjacent to the bottom 18 of the shell 12. The pump 28 is configured to draw the deicing solution through the first pipe 40.

A tube 44 is fluidically coupled to the pump 28 and extends from the shell 12. The tube 44 is flexible. The pump 28 is configured to motivate the deicing solution from the interior space 14 through the tube 44. In one embodiment, an orifice 46 is positioned through the shell 12 proximate to the top 20 and a front 38 of the shell 12. The tube 44 is positioned through the orifice 46.

A nozzle 48 is coupled to the tube 44 distal from the shell 12. The nozzle 48 is configured to spray the deicing solution on a target, such as a window of a vehicle, such that ice on the target is melted.

A second pipe 50 is coupled to the top 20 of the shell 12. The second pipe 50 is fluidically coupled to the interior space 14. The second pipe 50 is configured to add the deicing solution to the interior space 14.

The device 10 comprises a cap 52 that is complementary to the second pipe 50. The cap 52 is configured to couple to the second pipe 50 to selectively close the second pipe 50. The cap 52 comprises a sidewall 54. In one embodiment, the sidewall 54 is internally threaded and the second pipe 50 is externally threaded. The sidewall 54 is positioned to threadedly couple to the second pipe 50 to selectively close the second pipe 50. In another embodiment, the sidewall 54 is externally textured. The sidewall 54 is configured to deter slippage of one or more digits of a hand of a user grasping the cap 52 to selectively couple the cap 52 to the second pipe 50.

A handle 56 is coupled to the shell 12. The handle 56 is configured to be grasped in the hand of the user to lift the shell 12. In one embodiment, a recess 66 extends into the shell 12 from the back 36 and the top 20 of the shell 12. In this embodiment, the handle 56 comprises a third pipe 58 that has opposing ends 60. The third pipe 58 is arcuate. Each opposing end 60 is coupled to the shell 12 so that the third pipe 58 is fluidically coupled to the interior space 14. The handle 56 is extends from the top and the back around the recess 66. Also in this embodiment, the tube 44 extends from the pump 28, through the third pipe 58, and then through the orifice 46.

A controller 62 is coupled to the shell 12. The controller 62 is operationally coupled to the pump 28 and the power module 26. The controller 62 is positioned to selectively couple the pump 28 to the power module 26. In one embodiment, the controller 62 comprises a button 64 that is coupled to the handle 56 proximate to the top 20 of the shell 12. The button 64 is depressible. The button 64 is configured to be depressed to selectively couple the pump 28 to the power module 26.

In use, the second pipe 50 is configured to add the deicing solution to the interior space 14. The cap 52 is configured to couple to the second pipe 50 to selectively close the second pipe 50. The handle 56 is configured to be grasped in the hand of the user to lift the shell 12. The button 64 that is positioned on the handle 56 is configured to be depressed to selectively couple the pump 28 to the power module 26. The pump 28 is configured to motivate the deicing solution from the interior space 14 through the tube 44. The nozzle 48 is configured to spray the deicing solution on the target, such as the window of the vehicle. The ice on the target is melted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spraying device comprising:
a shell defining an interior space, said shell being configured for positioning a deicing solution, such as windshield washing fluid;
a housing coupled to said shell, said housing defining an internal space;
a power module coupled to said housing and positioned in said internal space;
a pump coupled to said housing and positioned in said internal space, said pump being fluidically coupled to said interior space, said pump being operationally coupled to said power module;
a tube fluidically coupled to said pump and extending from said shell, said tube being flexible;
a nozzle coupled to said tube distal from said shell; and
wherein said tube is positioned on said pump such that said pump is configured for motivating the deicing solution from said interior space through said tube, wherein said nozzle is positioned on said tube such that said nozzle is configured for spraying the deicing solution on a target, such as a window of a vehicle, such that ice on the target is melted.

2. The device of claim 1, further including said shell comprising an annular wall extending from a bottom to a top, said bottom being substantially rectangularly shaped such that said shell is substantially rectangularly box shaped, said top being dimensionally smaller than said bottom such that said shell is tapered.

3. The device of claim 1, further including said housing being positioned proximate to a bottom and a back of said shell.

4. The device of claim 1, further including said power module comprising a cable and a connector, said cable extending from said housing, said connector being coupled to said cable distal from said housing.

5. The device of claim 4, further including said connector comprising a cigarette lighter plug.

6. The device of claim 1, further including a first pipe fluidically coupled to and extending from said pump, said first pipe being positioned through said housing such that an open end of said first pipe is positioned in said interior space adjacent to a bottom of said shell, wherein said first pipe is positioned on said pump such that said pump is configured for drawing the deicing solution through said first pipe.

7. The device of claim 1, further including an orifice positioned through said shell proximate to a top and a front of said shell, said tube being positioned through said orifice.

8. The device of claim 1, further including a second pipe coupled to a top of said shell, said second pipe being fluidically coupled to said interior space, wherein said second pipe is positioned on said shell such that said second pipe is configured for adding the deicing solution to said interior space.

9. The device of claim 8, further including a cap complementary to said second pipe, said cap being configured for coupling to said second pipe for selectively closing said second pipe.

10. The device of claim 9, further comprising:
said second pipe being externally threaded;
said cap comprising a sidewall, said sidewall being internally threaded; and
wherein said sidewall is positioned for threadedly coupling to said second pipe for selectively closing said second pipe.

11. The device of claim 10, further including said sidewall being externally textured such that said sidewall is configured for deterring slippage of one or more digits of a hand of a user grasping said cap for selectively coupling said cap to said second pipe.

12. The device of claim 7, further including a handle coupled to said shell, wherein said handle is positioned on said shell such that said handle is configured for grasping in the hand of the user for lifting said shell.

13. The device of claim 12, further including a recess extending into said shell from a back and a top of said shell, said handle comprising a third pipe having opposing ends, said third pipe being arcuate, each said opposing end being coupled to said shell such that said third pipe is fluidically coupled to said interior space, and such that said handle extends from said top and said back around said recess, said tube extending from said pump, through said third pipe, and then through said orifice.

14. The device of claim 13, further including a controller coupled to said shell, said controller being operationally coupled to said pump and said power module, wherein said controller is positioned on said shell such that said controller is positioned for selectively coupling said pump to said power module such that said pump is configured for motivating the deicing solution from said interior space through said tube such that said nozzle is configured for spraying the deicing solution on the target, such as the window of the vehicle, such that the ice on the target is melted.

15. The device of claim 14, further including said controller comprising a button coupled to said handle proximate to said top of said shell, said button being depressible, wherein said button is positioned on said handle such that said button is configured for depressing for selectively coupling said pump to said power module such that said pump is configured for motivating the deicing solution from said interior space through said tube such that said nozzle is configured for spraying the deicing solution on the target, such as the window of the vehicle, such that the ice on the target is melted.

16. A spraying device comprising:
a shell defining an interior space, said shell being configured for positioning a deicing solution, such as windshield washing fluid, said shell comprising an annular wall extending from a bottom to a top, said bottom being substantially rectangularly shaped such that said shell is substantially rectangularly box shaped, said top being dimensionally smaller than said bottom such that said shell is tapered;
a housing coupled to said shell, said housing defining an internal space, said housing being positioned proximate to said bottom and a back of said shell;
a power module coupled to said housing and positioned in said internal space, said power module comprising a cable and a connector, said cable extending from said housing, said connector being coupled to said cable distal from said housing, said connector comprising a cigarette lighter plug;
a pump coupled to said housing and positioned in said internal space, said pump being fluidically coupled to said interior space, said pump being operationally coupled to said power module;
a first pipe fluidically coupled to and extending from said pump, said first pipe being positioned through said housing such that an open end of said first pipe is positioned in said interior space adjacent to said bottom of said shell, wherein said first pipe is positioned on said pump such that said pump is configured for drawing the deicing solution through said first pipe;
a tube fluidically coupled to said pump and extending from said shell, said tube being flexible, wherein said tube is positioned on said pump such that said pump is configured for motivating the deicing solution from said interior space through said tube;
an orifice positioned through said shell proximate to said top and a front of said shell, said tube being positioned through said orifice;
a nozzle coupled to said tube distal from said shell, wherein said nozzle is positioned on said tube such that said nozzle is configured for spraying the deicing solution on a target, such as a window of a vehicle, such that ice on the target is melted;
a second pipe coupled to said top of said shell, said second pipe being fluidically coupled to said interior space, wherein said second pipe is positioned on said shell such that said second pipe is configured for adding the deicing solution to said interior space, said second pipe being externally threaded;
a cap complementary to said second pipe, said cap being configured for coupling to said second pipe for selectively closing said second pipe, said cap comprising a sidewall, said sidewall being internally threaded such that said sidewall is positioned for threadedly coupling to said second pipe for selectively closing said second pipe, said sidewall being externally textured such that said sidewall is configured for deterring slippage of one or more digits of a hand of a user grasping said cap for selectively coupling said cap to said second pipe;
a handle coupled to said shell, wherein said handle is positioned on said shell such that said handle is configured for grasping in the hand of the user for lifting said shell;
a recess extending into said shell from said back and said top of said shell, said handle comprising a third pipe having opposing ends, said third pipe being arcuate, each said opposing end being coupled to said shell such that said third pipe is fluidically coupled to said interior space, and such that said handle extends from said top and said back around said recess, said tube extending from said pump, through said third pipe, and then through said orifice;
a controller coupled to said shell, said controller being operationally coupled to said pump and said power module, wherein said controller is positioned on said shell such that said controller is positioned for selectively coupling said pump to said power module such that said pump is configured for motivating the deicing solution from said interior space through said tube such that said nozzle is configured for spraying the deicing solution on the target, such as the window of the vehicle, such that the ice on the target is melted, said controller comprising a button coupled to said handle proximate to said top of said shell, said button being depressible, wherein said button is positioned on said handle such that said button is configured for depressing for selectively coupling said pump to said power module such that said pump is configured for motivating the deicing solution from said interior space through said tube such that said nozzle is configured for spraying the deicing solution on the target, such as the window of the vehicle, such that the ice on the target is melted; and
wherein said second pipe is positioned on said shell such that said second pipe is configured for adding the deicing solution to said interior space, wherein said cap is configured for coupling to said second pipe for selectively closing said second pipe, wherein said handle is positioned on said shell such that said handle is configured for grasping in the hand of the user for lifting said shell, wherein said button is positioned on said handle such that said button is positioned for selectively coupling said pump to said power module such that said pump is configured for motivating the deicing solution from said interior space through said tube such that said nozzle is configured for spraying the deicing solution on the target, such as the window of the vehicle, such that the ice on the target is melted.
